(19) United States
(12) Patent Application Publication
(10) Pub. No.: US 2025/0378183 A1
(43) Pub. Date: Dec. 11, 2025

(54) Detection of Host Container Monitoring

(71) Applicant: Telefonaktiebolaget LM Ericsson (publ), Stockholm (SE)

(72) Inventors: Henrik Normann, Malmö (SE); Lina Pålsson, Genarp (SE); Mikael Eriksson, Alingsås (SE)

(21) Appl. No.: 18/876,981

(22) PCT Filed: Jun. 23, 2022
(86) PCT No.: PCT/EP2022/067169

§ 371 Date: Dec. 19, 2024

(51) Int. Cl. G06F 21/60

(52) U.S. Cl. CPC G06F 21/602

(57) ABSTRACT

Embodiments of the present disclosure provide a method (300) for securing a first tenant container (25) executed by a first computing device (102). The method (300) being performed within the first tenant container (25) by the first computing device (102). The method (300) comprises detecting (302) whether a probe (40) for collecting information related to the first tenant container (25) is enabled within one or more processes being executed on the first computing device (102). Upon detection that the probe (40) for collecting the information related to the first tenant container (25) is enabled, the method (300) comprises generating (304) information indicating that the probe (40) is enabled on the first tenant container (25). In response to detection, the method (300) comprises performing one or more of transmitting (306) the generated information indicating that the probe (40) is enabled along with the information related to the first tenant container (25) to a second tenant container (50) or a second computing device (104); logging the detection of the probe (40); and modifying at least one functionality within the first tenant container. Corresponding computing device, and computer program products are also disclosed.

### TECHNICAL FIELD

The present disclosure relates generally to the field of cloud security systems. More particularly, it relates to method, computing device and computer program products for securing collection of information related to a tenant container.

### BACKGROUND

Traditionally network functions representing a cellular network have been represented by physical devices. For example, a dedicated hardware has been deployed for a certain network function or for a set of network functions. Over time, a concept of virtualization has been emerged in parallel with emergence of fifth generation, 5G, networks. The virtualization involves a transition of the network function from the dedicated hardware to commercial of the shelf hardware, thereby providing flexibility for both scaling and hosting of the network functions.

Further, clause 8 in “Network Functions Virtualisation (NFV) Use Cases” from of European Telecommunications Standards Institute, ETSI, standards describes transformation of use cases that are enabled by the virtualization. One of the use cases is that companies that used to purchase a dedicated hardware and host machines themselves can nowadays purchase a functionality packed as containers. For example, the functionality may correspond to the network functions of the cellular network.

With the emergence of the virtualization, various mechanisms for providing virtualized computing resources are evolving. For instance, container technologies and corresponding container clustering platforms are emerging as a solution for implementing flexible and scalable application virtualization mechanisms. In such mechanisms, the network functions/any other applications may be implemented using a set of containers, for example, with different functions that are provisioned on a set of computing resources. The computing resources can be physical computing resources or virtual computing resources such as virtualized in a data center or multiple data centers or container clustering platforms.

Containers are used for virtualization of computers or, more specifically, computer software applications. A container separates the application from an operating system and a physical infrastructure it uses to connect to a computing network. The use of containers, for example, Docker, is known to enable rapid provisioning within clusters and cloud environments. Docker is an open platform container runtime for developers and system administrators to build and run distributed applications as containers.

Typically, a container refers to a software package that may be executed in a computing device. The container may be provided as a service which is commonly referred to as Container as a Service, CaaS. In accordance with CaaS, an organization provides runtime and resources for another organization to deploy their container(s) in a public cloud. The organization hosting the containers may be known as a cloud service provider, CSP, or an infrastructure provider. In some examples, the CSP/infrastructure provider may be a hyperscale provider, a communication service provider, or the like. The organization that provides the container to the CSP is typically referred to as a tenant. The CSP can host and execute many tenant containers producing a lot of valuable information. Some of the information the containers produce are metadata and general logging data while other information within the container may be sensitive. Further, an organization providing the container to the tenant is typically referred as a vendor of the container.

The Extended Berkeley Packet Filter, eBPF technology may be used to collect information from the container. The eBPF technology may execute sandbox programs in a Linux kernel to collect information from the container. A strength of the eBPF technology is that the information can be collected from the container without affecting a behaviour of the kernel or without changing the kernel itself or without affecting the kernel by adding kernel modules. Using the eBPF technology, one or more probes may be enabled on the container to collect the sensitive information from the container before encryption at a sender's side or after decryption at a recipient's side. In some instances, the probe may collect the information related to the container without an intent of the container. The collected information related to the container may be used in an unauthorized manner.

### SUMMARY

It is important to detect that the information from the container is being collected by the one or more probes. However, solutions/techniques available for detecting that the information from the container is being collected require adaptations outside the container's namespace.

Consequently, there is a need for an improved method and arrangement for securing a tenant container that alleviates at least some of the above cited problems.

It is therefore an object of the present disclosure to provide a method, a computing device, and a computer program product for securing a tenant container, to mitigate, alleviate, or eliminate all or at least some of the above-discussed drawbacks of presently known solutions.

This and other objects are achieved by means of a method, a computing device, and a computer program product as defined in the appended claims. The term exemplary is in the present context to be understood as serving as an instance, example or illustration.

According to a first aspect of the present disclose, a method for securing a first tenant container executed by a first computing device is provided. The method being performed within the first tenant container by the first computing device. The method comprises detecting whether a probe for collecting information related to the first tenant container is enabled within one or more processes being executed on the first computing device. Upon detection that the probe for collecting the information related to the first tenant container is enabled, the method comprises generating information indicating that the probe is enabled on the first tenant container. In response to the detection, the method comprises performing one or more of: transmitting the generated information indicating that the probe is enabled along with the information related to the first tenant container to a second tenant container or a second computing device; logging the detection of the probe; and modifying at least one functionality within the first tenant container.

In some embodiments, the method further comprises encrypting the generated information indicating that the probe is enabled along with the information related to the first tenant container.

In some embodiments, the method further comprises transmitting the information for execution of the encryption in a secure environment before transmission.

In some embodiments, the step of detecting whether the probe is enabled within the one or more processes being executed on the first computing device for collecting the information related to the first tenant container comprises receiving a request for a probe status indicating whether the first tenant container is probed for collecting the information related to the first tenant container. Upon receiving the request, the method comprises verifying whether the probe is enabled within the one or more processes being executed on the first computing device.

In some embodiments, the request for the probe status is received from one or more of: the second tenant container residing in the first computing device, a tenant container external to the first computing device, and the second computing device.

In some embodiments, the step of detecting whether the probe is enabled within the one or more processes being executed on the first computing device comprises monitoring one or more libraries of the first tenant container and identifying whether one or more libraries of the first tenant container are being accessed from outside of the first tenant container.

In some embodiments, the step of detecting whether the probe is enabled within the one or more processes being executed on the first computing device comprises identifying whether at least one file belonging to the first tenant container is being accessed by a process external to the first tenant container.

In some embodiments, the at least one file comprises one or more of: a cryptographic key, and a filtering rule set.

In some embodiments, the generated information comprises one or more of: an identity of the first computing device, a geographical location of the first computing device, a provider identity of the first computing device, information about a central processing unit, CPU of the first computing device, information about a kernel of the first computing device, information about available drivers of the first computing device, and information about a result of identifying whether the at least one file belonging to the first tenant container is being accessed by the process external to the first tenant container.

In some embodiments, the method further comprises performing one or more of: aborting transmission of the information from the first tenant container, transmitting only specific or at least some of the information related to the first tenant container, transmitting an indication that the first tenant container is probed for collection of the information by the one or more processes executed by the first computing device, aborting execution of one or more functions and/or libraries of the first tenant container when the probe is enabled, and transmitting an indication to indicate that the one or more functions of the first tenant container to be moved to another computing device.

According to a second aspect of the present disclosure, a method for securing a first tenant container is provided. The method being performed within a second tenant container by a second computing device. The method comprises transmitting a request to the first tenant container being executed on a first computing device for a probe status indicating whether the first tenant container is probed for collecting the information related to the first tenant container. The method comprises receiving, from the first tenant container, information indicating whether the probe is enabled on the first tenant container along with the information related to the first tenant container. Upon reception of the information indicating that the probe is enabled, the method comprises controlling transmission of information related to the second tenant container to the first tenant container.

In some embodiments, the step of receiving the information indicating whether the probe is enabled on the first tenant container along with the information related to the first tenant container comprises receiving, from the first tenant container, an indication that one or more processes being executed on the first computing device are collecting the information related to the first tenant container in accordance with a filtering rule set.

In some embodiments, the step of controlling transmission of the information related to the second tenant container comprises terminating transmission of the information related to the second tenant container to the first tenant container, rejecting the first tenant container as a receiver, and delivering the information related to the first tenant container only to a secure environment within the first tenant container.

In some embodiments, the received information comprises one or more of: an identity of the first computing device, a geographical location of the first computing device, a provider identity of the first computing device, information about a central processing unit, CPU of the first computing device, information about a kernel of the first computing device, and information about available drivers of the first computing device.

According to a third aspect of the present disclosure, a first computing device for securing a first tenant container from within the first tenant container is provided. The first computing device being adapted for detecting whether a probe for collecting information related to the tenant container is enabled within one or more processes being executed on the first computing device. Upon detection that the probe for collecting the information related to the first tenant container is enabled, the first computing device is adapted for generating information indicating that the probe is enabled on the tenant container. In response to detection, the first computing device is adapted for performing one or more of: transmitting the generated information indicating that the probe is enabled along with the information related to the first tenant container to a second tenant container or a second computing device; logging the detection of the probe; and modifying at least one functionality within the first tenant container.

According to a fourth aspect of the present disclosure, a second computing device for securing a first tenant container from within a second tenant container is provided. The second computing device being adapted for transmitting a request to the first tenant container being executed on a first computing device for a probe status indicating whether the first tenant container is probed for collecting the information related to the first tenant container. The second computing device is adapted for receiving, from the first tenant container, information indicating whether the probe is enabled on the first tenant container along with the information related to the first tenant container. Upon reception of the information indicating that the probe is enabled, the second computing device is adapted for controlling transmission of information related to the second tenant container to the first tenant container.

According to a fifth aspect of the present disclosure, there is provided a computer program product comprising a non-transitory computer readable medium, having thereon a computer program comprising program instructions, the computer program is loadable into a data processing unit and configured to cause execution of the method according to any of the first and second aspects when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for securing the tenant container.

An advantage of some embodiments is that the tenant container can be secured by monitoring sensitive libraries, or any other libraries of the tenant container for which the probe is enabled to collect the information from ongoing information exchange. The sensitive libraries or any other libraries may be monitored from within the tenant container.

An advantage of some embodiments is that the tenant container can be secured by detecting anomalies, which anomalies indicate that the probe for monitoring the one or more sensitive libraries of the tenant container is enabled within one or more processes being executed on the computing device.

An advantage of some embodiments is that the tenant container can be secured by generating information indicating that the probe is enabled on the tenant container and transmitting the generated information indicating that the probe is enabled along with the information related to the tenant container to the second tenant container or the second computing device.

An advantage of some embodiments is that setting up of the probe targeting the libraries within the namespace of the tenant container may be easily identified. Such an identification provides a strong indication and awareness of if the information related to the tenant container is intercepted and likely exist elsewhere without an intention of the tenant container.

An advantage of some embodiments is that the probe enabled on the tenant container may be identified without involving any additional entity expect a vendor producing the tenant container. In addition, actions may be implemented in the tenant container itself to mitigate effects of existence of such a probe.

An advantage of some embodiments is that mutual benefits may be provided to both a cloud service provider, CSP, and an observability tool provider by providing a technical means within the tenant container for detecting when the collection of the information related to the tenant container occurs. As a result, in the events of data leakage, the tenant container may confirm that the observability tool has not extracted any of the leaked information.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses a block diagram illustrating examples of computing devices connected to a network;

FIGS. 2A and 2B disclose an example implementation for securing information related to a tenant container;

FIG. 3 is a flowchart illustrating example method steps according to some examples;

FIG. 4 is a flowchart illustrating example method steps according to some examples;

FIG. 5A is a schematic block diagram illustrating an example apparatus according to some examples;

FIG. 5B is a schematic block diagram illustrating an example apparatus according to some examples;

FIG. 6 is a flowchart illustrating example method steps according to some examples;

FIG. 7 is a flowchart illustrating example method steps according to some examples;

FIG. 8 is a flowchart illustrating example method steps according to some examples;

FIG. 9 is a flowchart illustrating example method steps according to some examples;

FIG. 10 is a flowchart illustrating example method steps according to some examples;

FIG. 11 is a signaling diagram illustrating example signaling according to some examples;

FIG. 12 is a signaling diagram illustrating example signaling according to some examples; and

FIG. 13 discloses an example computing environment according to some examples.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

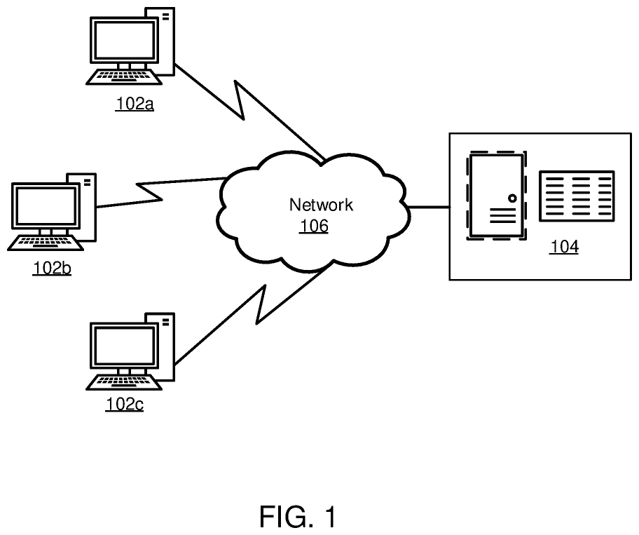

FIG. 1 discloses a block diagram illustrating computing devices connected to a network. As depicted in FIG. 1, there may be a plurality of computing devices 102a, 102b, and 102c connected to a network 106. Further, there exists a second computing device 104 that communicates with the computing devices 102a, 102b, and 102c by connecting to the network 106. The network 106, for example, may be an informational technology network, an operational technology network, a cloud infrastructure, a software as a service, SaaS, infrastructure or any combination thereof, connected to each of the computing devices 102a, 102b and 102c and the second computing device 104.

In some examples, the computing devices 102a, 102b, and 102c (hereinafter which may be collectively referred to as a computing device/host/first computing device 102) and the second computing device 104 may include, but are not limited to, a server, a computing device, a multi-processor system, a microprocessor-based or programmable consumer electronic device, a network computing device, or a combination thereof. The computing device 102/104 may include a cellular phone, a personal digital assistant, PDA, a handheld device, a laptop computer, or a combination thereof.

The first computing device 102 comprises one or more tenant containers and that the tenant containers (or at least some of them) are hosted by a cloud service provider, CSP. A plurality of applications, for example, including network functions representing a cellular network, may be implemented using the tenant containers. In some examples, information (also referred to as data, data packets, or the like) the tenant container produce may include, but are not limited to, metadata, general logging, sensitive/valuable information, and so on.

Further, the tenant containers may include different functions that are provisioned on a set of computing resources. In some examples, the computing resources may include physical computing resources, or virtual computing resources such as virtualized in a data center or multiple data centers or container clustering platforms.

The first computing device 102 enables its tenant container, for example, a first tenant container, to transmit the information to a second tenant container, or a second computing device 104. The first computing device 102 also enables its first tenant container to receive the information from the second tenant container or the second computing device 104. In some examples, the second computing device 104 may comprise one or more tenant containers. In other examples, the second computing device 104 may not comprise any tenant container (i.e., a non-container entity). In some examples, the second tenant container may reside in the first computing device 102. In some examples, the second tenant container may reside external to the first computing device 102, for example, may reside in the second computing device 104.

Further, a probe is enabled within one or more processes being executed on the first computing device 102 for collecting the information related to the tenant container, for example, the first tenant container being executed on the first computing device 102. In some examples, the probe may be enabled from outside of a namespace of the first tenant container to collect the information. In some examples, the probe may be an Extended Berkeley Packet Filter, eBPF probe. In some example, the probe may collect the information related to the first tenant container during an ongoing exchange of the information between the first tenant container and the second tenant container/the second computing device 104.

In some examples, the one or more probes may collect the information related to the first tenant container without an intent of the first tenant container, which results in potential exposure of sensitive information. The collected information related to the first tenant container may be used in an unauthorized manner. Therefore, it is important to detect that the information from the tenant containers is being collected by the one or more probes. Exemplary solutions available for detecting the collection of the information by the one or more probes from the tenant containers require adaptations outside the namespace of the tenant containers.

Therefore, the first computing device 102 implements a method capable of efficiently securing the information related to the first tenant container executed on the first computing device 102. The method being performed within the first tenant container executed by the first computing device 102. It should be noted that any of the first computing devices 102a, 102b and 102c, hereinafter referred to as 102, may implement the method for securing the information related to the respective tenant container.

The first computing device 102 is adapted to detect whether a probe for collecting the information related to the first tenant container is enabled within one or more processes being executed on the first computing device 102. Upon detection that the probe for collecting the information related to the first tenant container is enabled, the first computing device 102 is adapted to generate information indicating that the probe is enabled on the first tenant container. In response to detection, the first computing device 102 is also adapted to perform one or more of: transmitting the generated information indicating that the probe is enabled along with the information related to the first tenant container to the second tenant container or the second computing device 104; logging the generated information indicating that the probe is enabled; and modifying at least one functionality within the first tenant container. In some examples, the second tenant container may reside in the first computing device 102. In some examples, the second tenant container may reside external to the first computing device 102. In some examples, the second computing device 104 may comprise one or more tenant containers. In some examples, the second computing device 104 may be a non-container entity without comprising any tenant containers.

Optionally, the first computing device 102 may also be adapted to encrypt the generated information indicating that the probe is enabled along with the information related to the first tenant container.

A second computing device 104 also implements a method for efficiently securing the information related to the first tenant container. The first tenant container is being executed on the first computing device 102 and the second tenant container is being executed on the second computing device 104. It should be noted that the first computing device 102 may also implement the method for securing the information related to the first tenant container from within the second tenant container, wherein the second tenant container may reside in the first computing device 102.

The second computing device 104 is adapted to transmit a request to the first tenant container being executed on the first computing device for a probe status indicating whether the first tenant container is probed for collecting the information related to the first tenant container. The second computing device 104 is adapted to receive, from the first tenant container, information indicating whether the probe is enabled on the first tenant container along with the information related to the first tenant container. Upon reception of the information indicating that the probe is enabled, the second computing device 104 is adapted to control transmission of information related to the second tenant container to the first tenant container.

Thus, setting up of the probe targeting the tenant container may be easily identified from within the same tenant container. Such an identification provides a strong indication and awareness of if the information related to the tenant container is being intercepted.

Various examples for securing the information related to the tenant container are explained in conjunction with figures in the later parts of the description.

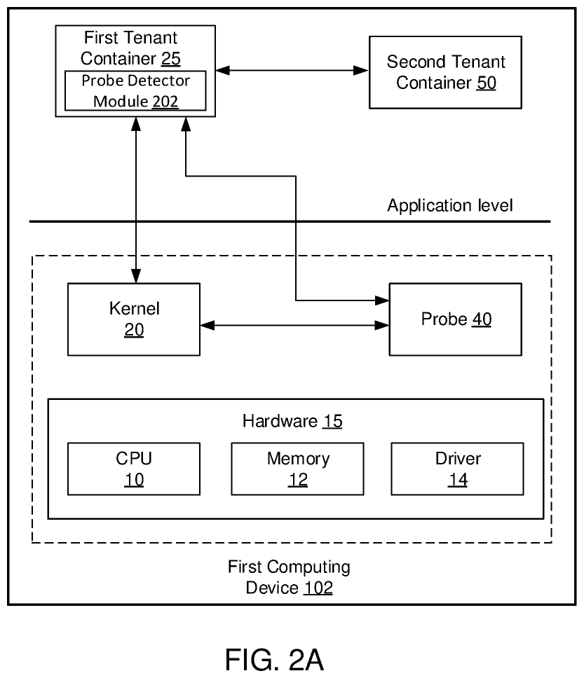

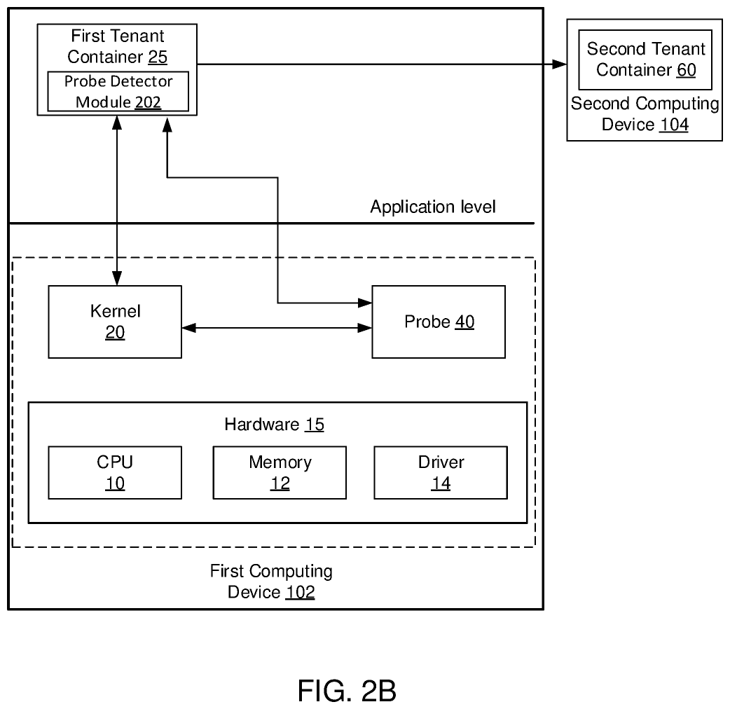

FIGS. 2A and 2B disclose an example implementation for securing information related to the tenant container.

The first computing device 102 comprises one or more tenant containers to implement one or more applications, for example, including network functions representing a cellular network. In some examples, the tenant containers may be implemented at an application level. For simplicity, the first computing device 102 depicted in FIGS. 2A and 2B comprises a first tenant container 25. The first tenant container 25 may generate or produce information such as, but are not limited to, metadata, general logging data, sensitive or valuable information, and so on. The first tenant container 25 may adapted to transmit and/or receive the information to and/or from a second tenant container 50. In some examples, the second tenant container 50 may reside in the same first computing device 102, as depicted in FIG. 2A. In some examples, the second tenant container 50 may be a tenant container 60 (also be referred to as a second tenant container 60) reside in the second computing device 104, as depicted in FIG. 2B.

In some examples, the second computing device 104 may be a container entity i.e., the second computing device 104 may comprise one or more tenant containers, for example, the second tenant container 60, as depicted in FIG. 2B. In some examples, the second computing device 104 may be a non-container entity i.e., the second computing device 104 may not comprise any tenant containers (not shown).

The first tenant container 25 may be instantiated within a kernel 20 of an operating system, OS. The first tenant container 25 virtualizes an instance of the applications. The first tenant container 25 does not include the operating system like a virtual machine. The use of tenant container(s) 25 enable execution of multiple applications using same computing resources of the first computing device 102. In some examples, the computing resources may include an underlying hardware 15. The underlying hardware 15 includes a central processing unit 10, memory 12, and drivers 14. Typically, the first tenant container 25/second tenant container 50/60 does not have externally available Internet Protocol, IP, address of its own, although it has a unique ID that may be used by a CSP that hosts the first tenant container 25. A server of the CSP manages the first tenant container 25 and the first tenant container 25 manages an application code. A tenant has no control or ownership of the underlying hardware 15 including the CPU 10, the memory 12, and the drivers 14.

Further, in order to collect the information related to the first tenant container 25, a probe 40 is enabled within one or more processes (not shown) executed on the first computing device 102. In some examples, the probe 40 may be enabled from outside of a namespace of the first tenant container 25.

A probe detector module 202 is implemented within the first tenant container 25 to detect the probe that is enabled to collect the information from the first tenant container 25. Upon detection that the probe is enabled, the first computing device 102 enables the first tenant container 25 to perform appropriate actions.

The probe detector module 202 detects whether the probe 40 for collecting the information related to the first tenant container 25 is enabled within the one or more processes being executed on the first computing device 102.

In some examples, the probe detector module 202 detects whether the probe 40 is enabled, when the first tenant container 25 is being executed on the first computing device 102.

In some examples, the probe detector module 202 detects whether the probe 40 is enabled, upon reception of a probe status enquiry from one or more of: the second tenant container 50 residing in the first computing device 102, the second tenant container 60 residing external to the first computing device 102 (for example, residing in the second computing device 104), the second computing device 104 (for examples, the container entity or the non-container entity), or the like. The probe status indicates whether the first tenant container 25 is probed for collecting the information related to the first tenant container 25.

In order to detect whether the probe 40 is enabled, the probe detector module 202 monitors one or more libraries of the first tenant container 25 for identifying whether the one or more libraries of the first tenant container 25 are being accessed from outside the first tenant container 25. In some examples, the one or more libraries correspond to a library used for transport encryption. One of the examples of the libraries may be an openssl library.

When it has been determined that the one or more libraries of the first tenant container are being accessed outside from the first tenant container 25, the probe detector module 302 detects that the probe 40 is enabled to collect the information related to the first tenant container 25. In some examples, the probe detector module 202 detects whether the probe 40 has been enabled by distinguishing characteristics associated with a normal usage of the libraries and characteristics associated with accessing of the libraries by the probe 40 from outside the first tenant container 25.

For example, consider that the probe detector module 302 monitors a library of the first tenant container 25, i.e., an openssl library. In such instances, the probe detector module 302 identifies that a number of accesses caused to the openssl library may be around 90 within a second. In the above scenario, the probe detection module 302 detects that the probe 40 is enabled to collect the information related to the first tenant container 25, as the normal usage of the openssl library for setup of Transport Layer Security, TLS, layer encryption and decryption causes significantly fewer accesses.

In order to detect whether the probe 40 is enabled, the probe detector module 202 may identify whether at least one file belonging to the first tenant container 25 is being accessed by a process being executed external to the first tenant container 25. The at least one file may comprise one or more of: a cryptographic key, a filtering rule set, or the like. In some examples, the filtering rule set may be defined within the first tenant container 25, which comprises one or more filtering rules to be applied on the information related to the first tenant container 25. When it has been identified that the at least one file is being accessed by the process external to the first tenant container, the probe detector module 202 detects that the probe 40 is enabled to collect the information related to the first tenant container 25. However such a collection may be so called respectful container information collection. The term respectful container information collection indicates that the first computing device 102 itself executed the probe 40 to collect the information related to the first tenant container using the filtering rules on the collected information. In the disclosure herein, the terms such as “respectful container information collection”, “respectful container data interception”, “respectful probing”, or the like interchangeably to indicate valid collection of the information related to the first tenant container.

Upon detection that the probe 40 is enabled, the first tenant container 25 is adapted to generate information indicating that the probe 40 is enabled on the first tenant container 25.

The information indicating that the probe is enabled on the first tenant container 25 may comprise for example one or more of: an identity of the first computing device 102, a geographical location of the first computing device 102, a provider identity of the first computing device 102, information about the CPU 10, information about the kernel 20, information about available drivers 14, and information about a result of identifying whether the at least one file belonging to the first tenant container is being accessed by the process external to the first tenant container 25. In some examples, the information about the result may indicate whether the collection of the information related to tenant container is the respectful container information collection or not.

In response to the probe detection, the first tenant container 25 is adapted to perform one or more of: transmitting the generated information indicating that the probe is enabled along with the information related to the tenant container to the second tenant container 50 or the second computing device 104, and/or logging the detection of the probe or logging the generated information indicating that the probe 40 is enabled, and/or modifying at least one functionality within the first tenant container 25. In some examples, the second tenant container 50 may reside in the first computing device 102 (as depicted in FIG. 2A). In some examples, the second tenant container 50 may reside external to the first computing device 102, for example, the second tenant container 60 residing in the second computing device 104 (as depicted in FIG. 2B). In some examples, the second computing device 104 may be the container entity or the non-container entity. In some examples, the second computing device 104 may reside externally to the first computing device 102 or internally in the first computing device 102. In some examples, modifying the at least one functionality within the first tenant container 25 may comprise aborting transmission of the information from the first tenant container 25, aborting execution of one or more functions and/or libraries of the first tenant container 25 when the probe 40 is enabled, and so on.

In some examples, for transmission, the first tenant container 25 encrypts the generated information indicating that the probe is enabled along with the information related to the first tenant container 25 and transmits the encrypted information to the second tenant container 50 or the second computing device 104.

The first tenant container 25 is adapted to perform one or more actions based on one or more parameters associated with the first computing device 102, upon detection that the probe 40 is enabled. Examples of the parameters may include, but are not limited to, an identity of the first computing device 102, a geographical location of the first computing device 102, and so on.

In some examples, the one or more actions may include, but are not limited to,
transmitting the information for execution of the encryption in a secure environment before transmission. Examples of the secure environment may include, but are not limited to, a trusted execution environment, TEE, a virtualized micro environment or similar to Kata container. For example, upon detection that the probe is enabled, the tenant container may transmit the information for execution of the encryption from a TLS to a TEE;
aborting transmission of the information from the first tenant container 25;
transmitting only specific or at least some of the information related to the first tenant container 25;
transmitting an indication that the first tenant container 25 is probed for collection of the information by the one or more processes executed by the first computing device 102;
aborting execution of one or more functions and/or libraries of the first tenant container 25 when the probe 40 is enabled; and
transmitting an indication to indicate that one or more functions of the first tenant container 25 to be moved to another computing device. In some examples, transmitting the indication includes transmitting the indication to an upper layer (i.e., an application layer) for moving the functions of the first tenant container 25 to another computing device.

As depicted in FIG. 2B, the second computing device 104 may enable the second tenant container 60 to control transmission of the information from the second tenant container 60 to the first tenant container 25. Thereby, securing the first tenant container 25.

The second tenant container 60 is adapted to transmit a request to the first tenant container 25 being executed on the first computing device 102 for a probe status indicating whether the first tenant container 25 is probed for collecting the information related to the first tenant container 25.

The second tenant container 60 is adapted to receive, from the first tenant container 25, the information indicating whether the probe is enabled on the first tenant container 25 along with the information related to the first tenant container 25.

In some embodiments, the information indicating whether the probe is enabled may comprise one or more of: an identity of the first computing device 102, a geographical location of the first computing device 102, a provider identity of the first computing device 102, information about the CPU 10 of the first computing device 102, information about the kernel 20 of the first computing device 102, and information about the available drivers 30 of the first computing device 102.

Optionally, the second tenant container 60 may also receive, from the first tenant container 25, an indication that one or more processes being executed on the first computing device 102 are collecting the information related to the first tenant container 25 in accordance with the filtering rule set. Therefore, it is indicated a “respectful container information collection” is collected.

Upon reception of the information indicating that the probe 40 is enabled, the second tenant container 60 is adapted to control transmission of the information related to the second tenant container 60 to the first tenant container 25.

Optionally, the second tenant container 60 may be adapted to control the transmission by performing one or more of: terminating transmission of the information related to the second tenant container 60 to the first tenant container 25, rejecting the first tenant container 25 as receiver, and delivering the information related to the first tenant container 25 only to a secure environment within the first tenant container 25.

Thus, the information related to the tenant container may be secured by identifying the probe enabled on the tenant container without involving any additional entity except a vendor producing the tenant container and implementing actions in the tenant container itself to mitigate effects of existence of such a probe.

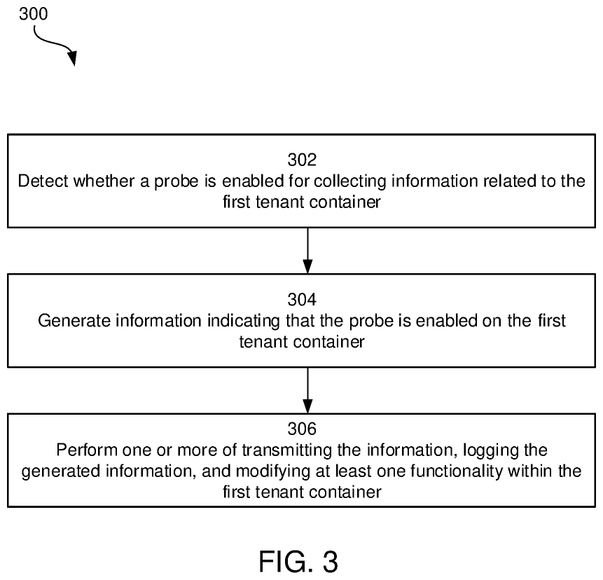

FIG. 3 is a flowchart illustrating example method steps of a method 300 performed by the first computing device. The method 300 may be performed within the first tenant container executed by the first computing device.

At step 302, the method 300 comprises detecting whether the probe for collecting information related to the first tenant container is enabled within one or more processes being executed on the first computing device.

The step 302 of detecting whether the probe is enabled within the one or more processes being executed on the first computing device for collecting the information related to the first tenant container may comprise receiving a request for a probe status indicating whether the tenant container is probed for collecting the information related to the tenant container. In some embodiments, the request for the probe status may be received from one or more of: the second tenant container residing in the first computing device, the tenant container residing external to the first computing device, and the second computing device. Upon receiving the request, the method may comprise verifying whether the probe detected as enabled within the one or more processes being executed on the first computing device.

The step 302 of detecting whether the probe is enabled within the one or more processes being executed on the first computing device for collecting the information related to the first tenant container may comprise monitoring one or more libraries of the first tenant container, and identifying whether the one or more libraries of the first tenant container are being accessed from outside the first tenant container.

The step 302 of detecting whether the probe is enabled within the one or more processes being executed on the first computing device for collecting the information related to the first tenant container may comprise identifying whether at least one file belonging to the first tenant container is being accessed by a process external to the first tenant container. In some examples, the at least one file comprises one or more of: a cryptographic key, and a filtering rule set.

Upon detecting that the probe for collecting the information related to the first tenant container is enabled, at step 304, the method 300 comprises generating information indicating that the probe is enabled on the first tenant container. In some examples, the generated information comprises one or more of: an identity of the first computing device, a geographic location of the first computing device, a provider identity of the first computing device, information about a CPU of the first computing device, information about a kernel of the computing device, information about available drivers of the first computing device, and information about a result of identifying whether the at least one file belonging to the first tenant container is being accessed by the process external to the first tenant container.

In response to the detection, at step 306, the method 300 comprises performing one or more of: transmitting the generated information indicating that the probe is enabled along with the information related to the first tenant container to the second tenant container or the second computing device; logging the detection of the probe; and modifying at least one functionality within the first tenant container. In some examples, the second tenant container may reside in the first computing device. In some examples, the second tenant container may be the tenant container residing externally to the first computing device. In some examples, the second computing device may be a container entity comprising one or more tenant containers. In some examples, the second computing device may be a non-container entity without comprising any tenant containers. In some examples, modifying the at least one functionality within the first tenant container may comprise aborting transmission of the information from the first tenant container, aborting execution of one or more functions and/or libraries of the first tenant container when the probe is enabled, and so on.

The method 300 may further comprise encrypting the generated information indicating that the probe is enabled along with the information related to the first tenant container.

The method 300 may further comprise transmitting the information for execution of the encryption in a secure environment before transmission.

The method 300 may further comprise performing one or more of: aborting transmission of the information from the first tenant container, transmitting only specific or at least some of the information related to the first tenant container, transmitting an indication that the first tenant container is probed for collection of the information by the one or more processes executed by the first computing device, aborting execution of one or more functions and/or libraries of the first tenant container when the probe is enabled, and transmitting an indication to indicate that the one or more functions of the first tenant container to be moved to another computing device.

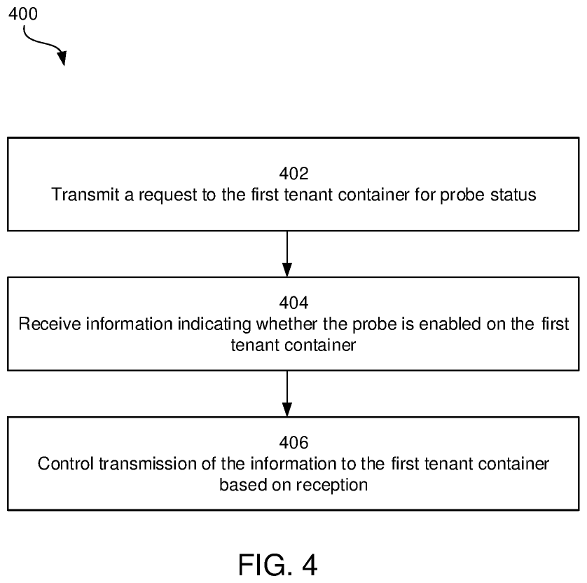

FIG. 4 is a flowchart illustrating example method steps of a method 400 performed by the second computing device within the second tenant container to secure the first tenant container being executed on the first computing device.

At step 402, the method 400 comprises transmitting a request to the first tenant container being executed on the first computing device for a probe status indicating whether the first tenant container is probed for collecting the information related to the first tenant container. At step 404, the method 400 comprises receiving, from the first tenant container, information indicating whether the probe is enabled on the first tenant container along with the information related to the first tenant container.

The information indicating whether the probe is enabled on the first tenant container may comprise one or more of: an identity of the first computing device, a geographic location of the first computing device, a provider identity of the first computing device, information about a CPU of the first computing device, information about a kernel of the first computing device, information about available drivers of the first computing device, and information about a result of identifying whether the at least one file belonging to the first tenant container is being accessed by the process external to the first tenant container.

The step 404 of receiving the information indicating whether the probe is enabled on the first tenant container along with the information related to the first tenant container may comprise receiving, from the first tenant container, an indication that one or more processes being executed on the first computing device are collecting the information related to the first tenant container in accordance with a filtering rule set. In some examples, the filtering rule set is stored in the first tenant container.

Upon reception of the information indicating that the probe is enabled, at step 406, the method 400 comprises controlling transmission of information related to the second tenant container to the first tenant container.

The step 406 of controlling the transmission may comprise performing one or more of: terminating transmission of the information related to the second tenant container to the first tenant container, rejecting the first tenant container as a receiver, and delivering the information related to the first tenant container only to a secure environment within the first tenant container.

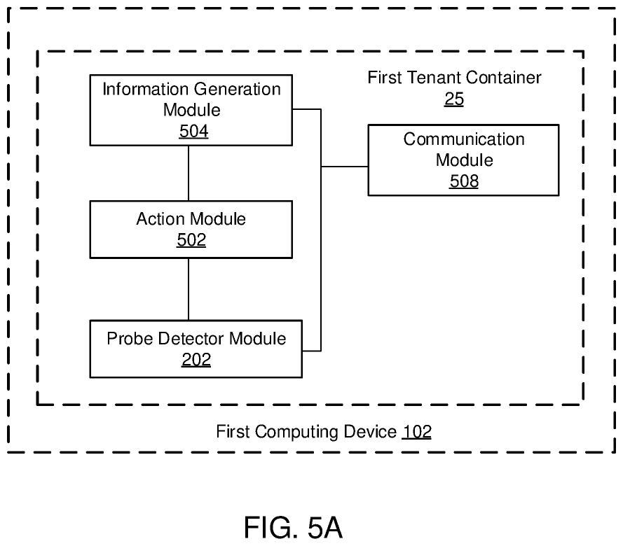

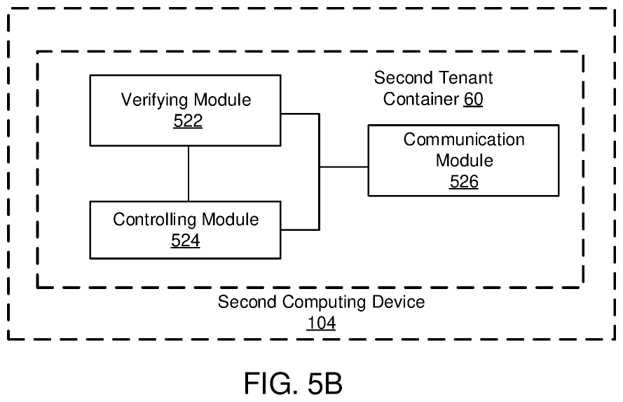

FIG. 5A is an example schematic block diagram showing functional modules of the first tenant container being executed on the first computing device. In accordance with an example herein, the first tenant container may be the first tenant container 25 being executed on the first computing device 102.

As depicted in FIG. 5A, the first tenant container 25 may include one or more modules configured to cooperate with each other for securing the information related to the first tenant container. For example, the first tenant container 25 may include the probe detector module 202, an information generation module 504, an action module 502, and a communication module 508.

The probe detector module 202 is adapted to detect whether the probe for collecting information related to the first tenant container 25 is enabled within one or more processes being executed on the first computing device 102.

The communication module 508 may be adapted to receive a request for a probe status indicating whether the probe for collecting information related to the first tenant container 25 is enabled within one or more processes being executed on the first computing device 102. In some embodiments, the request may be received from one or more of: the second tenant container residing in the first computing device 102, the tenant container residing external to the first computing device 102, and the second computing device.

The probe detector module 202 may also be adapted to verify whether the probe for collecting information related to the first tenant container 25 is enabled within one or more processes being executed on the first computing device 102, in response to the received request for the probe status. The probe detector module 202 is described in detail in conjunction with FIGS. 2A and 2B.

The information generation module 504 is adapted to generate information indicating that the probe is enabled on the first tenant container 25, upon detection that the probe for collecting the information related to the first tenant container 25 is enabled.

The action module 502 is adapted to modify at least one functionality within the first tenant container 25, in response to detection that the probe is enabled.

In some embodiments, the action module 502 may be adapted to associate/attach the generated information indicating that the probe is enabled with the information related to the first tenant container 25.

The communication module 508 is adapted to transmit the generated information indicating that the probe is enabled with the information related to the first tenant container 25 to the second tenant container or the second computing device.

In some embodiments, the action module 502 may also be adapted to encrypt the generated information indicating the probe is enabled along with the information related to the first tenant container for transmission.

In some embodiments, the action module 502 may also be adapted to enable transmission of the information for execution of the encryption in a secure environment before transmission. In some embodiments, the action module 502 may also be adapted to perform one or more of: logging the generated information, aborting transmission of the information from the first tenant container 25, enable transmission of only specific or at least some of the information related to the first tenant container 25, enable transmission of an indication that the first tenant container 25 is probed for collection of the information by the one or more processes executed by the first computing device 102, aborting execution of one or more functions and/or libraries of the first tenant container 25 when the probe is enabled, and enable transmission of an indication to indicate that the one or more functions of the first tenant container 25 to be moved to another computing device.

FIG. 5B is an example schematic block diagram showing functional modules of the second tenant container 60 being executed by the second computing device 104. In some examples, the second tenant container 60 may or may not comprise the probe detection module (described in FIGS. 2A, 2B, and 5A).

As depicted in FIG. 5B, the second tenant container 60 may include one or more modules configured to cooperate with each other for securing the information related to the first tenant container being executed on the first computing device. For example, the second tenant container 60 may include a verifying module 522, a controlling module 524, and a communication module 526.

The communication module 526 is adapted to transmit a request to the first tenant container being executed on the first computing device for a probe status. In response to the transmitted request, the communication module 526 is adapted to receive, from the first tenant container, information indicating whether the probe is enabled on the first tenant container along with the information related to the first tenant container.

The verifying module 522 may be adapted to verify whether the probe is enabled on the first tenant container, based on the information received by the communication module 526.

The controlling module 524 may be adapted to control transmission of the information related to the second tenant container 60 to the first tenant container, when it has been verified that the probe is enabled on the first tenant container. A step of controlling the transmission of the information related to the second tenant container 60 to the tenant container is described in detail in FIGS. 2A and 2B, and in step 406 of FIG. 4.

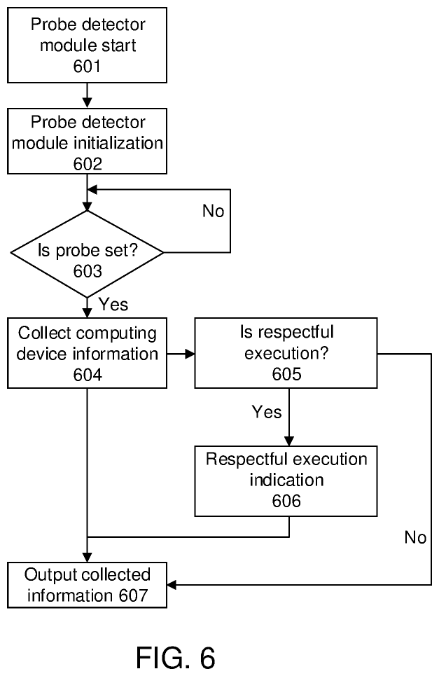

FIG. 6 is a flowchart illustrating example method steps performed by the probe detector module for detecting whether the probe is enabled on the tenant container to collect the information related to the tenant container. In accordance with an example herein, the tenant container may be the first tenant container being executed on the first computing device.

At step 601, the probe detector module starts operating within the first tenant container, when the first tenant container is being executed on the first computing device.

At step 602, the probe detector module may be initialized by the first tenant container. At step 603, the probe detector module checks whether the probe is set/enabled on the first tenant container to collect information related to the first tenant container. In some examples, the probe detector module checks if one or more libraries of the first tenant container provided for encryption are unexpectedly accessed. If the one or more libraries of the first tenant container are being accessed from outside the first tenant container, the probe detector module determines that the probe is enabled to collect the information related to the first tenant container.

Upon checking the probe is not enabled, the probe detector module repeats step 603 until a detection that the probe is enabled.

Upon detection that the probe is enabled, at step 604, the probe detector module collects the information related to the first computing device. Examples of the information related to the first computing device may include, but are not limited to, an identity of the first computing device, a geographical location of the first computing device, a provider identity of the first computing device, information about a CPU of the first computing device, information about a kernel of the first computing device, information about available drivers of the first computing device, and so on.

Once the information related to the first computing device has been collected, at step 605, the probe detector module identifies whether the collection of the information related to the first tenant container is respectful container information collection/execution. The respectful container collection information refers to accessing of the at least one file (such as, a cryptographic key, a filtering rule set, or the like) from the first tenant container by a process external to the first tenant container, wherein the process is hosted by the first computing device itself.

When it has not been identified that the collection of the information related to the first tenant container is the respectful container information collection/execution, the probe detector module performs step 607.

When it has been identified that the collection of the information related to the first tenant container is the respectful container information collection/execution, at step 606, the probe detector module generates a respectful execution indication. The respectful execution indication indicates the respectful container information/execution (i.e., valid collection of information).

At step 607, the probe detector module outputs the information related to the first computing device and the respectful execution indication to the first tenant container for further implementing actions to mitigate effects of the existing probe.

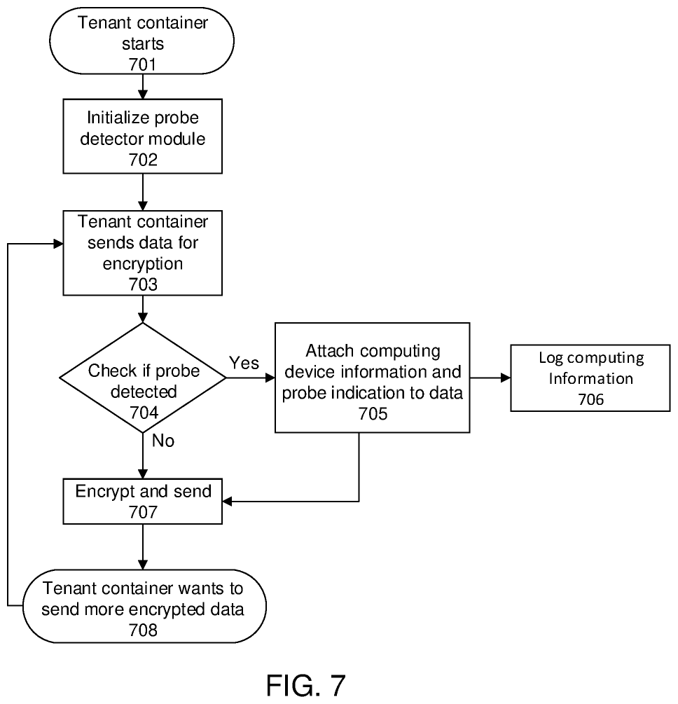

FIG. 7 is a flowchart illustrating example method steps performed by the tenant container on the computing device to secure its information. In accordance with an example herein, the tenant container may be the first tenant container being executed on the first computing device.

At step 701, the first tenant container is being executed on the first computing device. At step 702, the first tenant container initializes configurations of the probe detector module.

Upon being executed, at step 703, the first tenant container produces the information and sends the information (also be referred to as data, as depicted in FIG. 7) for encryption. In some examples, the information may include metadata, general logging, sensitive information, or the like.

At step 704, the first tenant container checks if the probe has been detected by the probe detector module on the first tenant container. The probe may be enabled from outside of the namespace of the first tenant container to collect the information related to the first tenant container.

Upon checking that the probe has not been detected, the first tenant container performs step 707, wherein the first tenant container encrypts the information related to the first tenant container and transmits the encrypted information to the second tenant container or the second computing device. In some examples, the second tenant container may reside in the first computing device. In some examples, the second tenant container may be the tenant container residing externally to the first computing device. In some examples, the second computing device may be a container entity comprising one or more tenant containers. In some examples, the second computing device may be a non-container entity without comprising any tenant containers. In some examples, the second computing device may reside externally to the first computing device or internally in the first computing device.

Upon checking that the probe has been detected, at step 705, the first tenant container generates information indicating that the probe is detected/enabled to collect the information related to the first tenant container. In some examples, the generated information includes information related to the first computing device and an indication (referred to as a probe indication, as depicted in FIG. 7) representing that the probe is enabled to collect the information related to the first tenant container. The first tenant container attaches the generated information to the information/data related to the first tenant container.

After attaching the generated information to the information/data related to the first tenant container, the first tenant container performs steps 706 and 707.

At step 706, the first tenant container logs the generated information.

At step 707, the first tenant container encrypts the information related to the first tenant container attached with the generated information and transmits the encrypted information to the second tenant container or the second computing device.

At step 708, the first tenant container identifies that more encrypted information has to be transmitted and starts performing from steps 703.

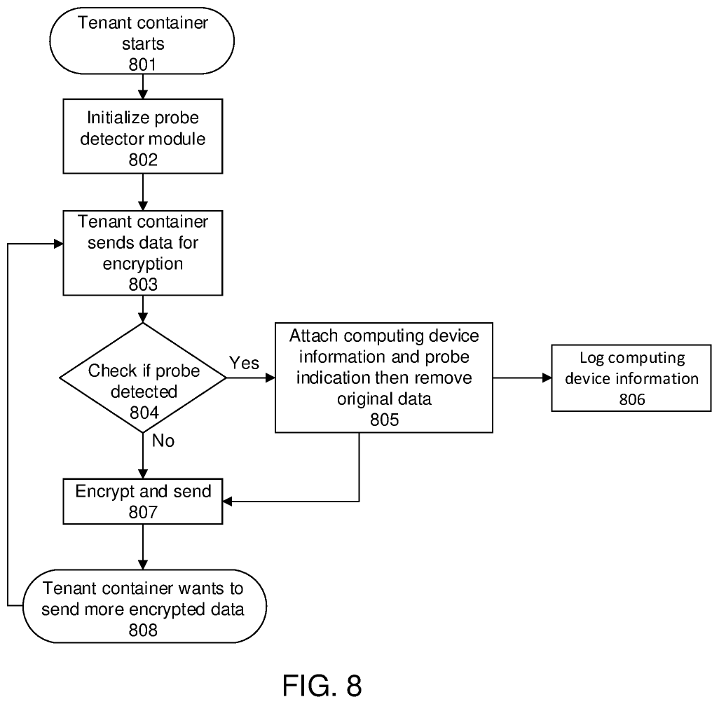

FIG. 8 is another flowchart illustrating example method steps performed by the tenant container on the computing device to secure its information. In accordance with an example herein, the tenant container may be the first tenant container being executed on the first computing device.

At step 801, the first tenant container is being executed on the first computing device. At step 802, the first tenant container initializes configurations of the probe detector module.

Upon being executed, at step 803, the first tenant container produces the information and sends the information (also be referred to as data, as depicted in FIG. 8) for encryption. In some examples, the information may include metadata, general logging, sensitive information, or the like.

At step 804, the first tenant container checks if the probe has been detected by the probe detector module on the first tenant container. The probe may enabled outside a namespace of the first tenant container to collect the information related to the first tenant container.

Upon checking that the probe has not been detected, the first tenant container performs step 807, wherein the first tenant container encrypts the information related to the first tenant container and transmits the encrypted information to the second tenant container or the second computing device. In some examples, the second tenant container may reside in the first computing device. In some examples, the second tenant container may be the tenant container residing externally to the first computing device. In some examples, the second computing device may be a container entity comprising one or more tenant containers. In some examples, the second computing device may be a non-container entity without comprising any tenant containers.

Upon checking that the probe has been detected, at step 805, the first tenant container attaches the information indicating that the probe is enabled to collect the information/data related to the first tenant container and removes its original information/data. In some examples, the information indicating that the probe is enabled includes information related to the first computing device and an indication (referred to as a probe indication, as depicted in FIG. 8) representing that the probe is enabled to collect the information related to the first tenant container.

After attaching the generated information to the information/data related to the first tenant container, the first tenant container performs steps 806 and 807.

At step 806, the first tenant container logs the generated information. At step 807, the first tenant container encrypts the information related to the first tenant container attached with the information indicating that the probe is enabled and transmits the encrypted information to the second tenant container or the second computing device.

At step 808, the first tenant container identifies that more encrypted information has to be transmitted and starts performing from steps 803.

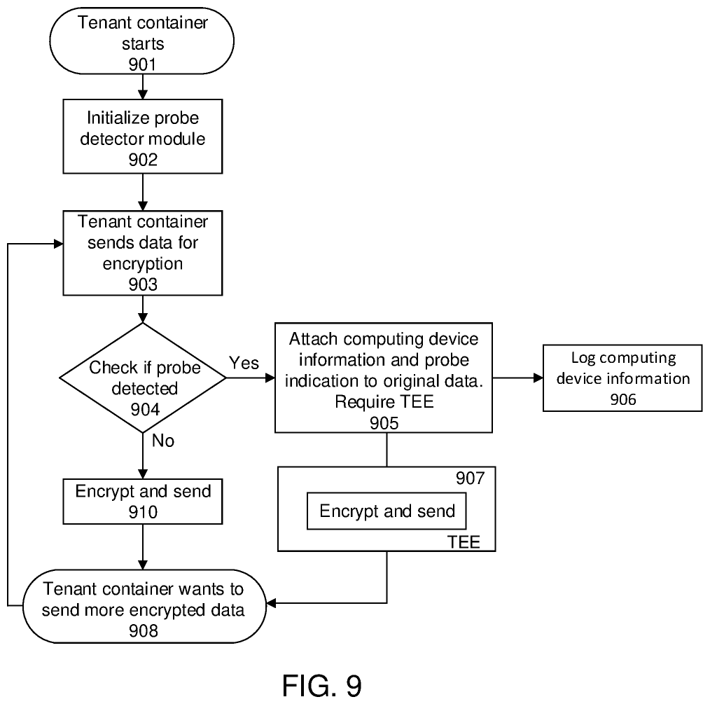

FIG. 9 is another flowchart illustrating example method steps performed by the tenant container on the computing device to secure its information. In accordance with an example herein, the tenant container may be the first tenant container being executed on the first computing device.

At step 901, the first tenant container initializes and after initialization, the first tenant container is executed on the first computing device. At step 902, the first tenant container initializes configurations of the probe detector module.

Upon being executed, at step 903, the first tenant container produces the information and sends the information (also be referred to as data, as depicted in FIG. 9) for encryption. In some examples, the information may include metadata, general logging, sensitive information, or the like.

At step 904, the first tenant container checks if the probe has been detected by the probe detector module on the first tenant container. The probe may be detected/enabled outside a namespace of the first tenant container to collect the information related to the first tenant container.

Upon checking that the probe has not been detected, the first tenant container performs step 910, wherein the first tenant container encrypts the information related to the first tenant container and transmits the encrypted information to the second tenant container or the second computing device. Thereafter, the first tenant container performs step 908. In some examples, the second tenant container may reside in the first computing device. In other examples, the second tenant container may be the tenant container residing externally to the first computing device. In some examples, the second computing device may be a container entity comprising one or more tenant containers. In some examples, the second computing device may be a non-container entity without comprising any tenant containers.

Upon checking that the probe has been detected, at step 905, the first tenant container attaches the information indicating that the probe is enabled to collect the information/data related to the first tenant container and removes its original information/data and identifies that the information has to be encrypted in a secure environment, for example, a TEE. In some examples, the information indicating that the probe is enabled includes information related to the computing device and an indication (referred to as a probe indication, as depicted in FIG. 9) representing that the probe is enabled to collect the information related to the tenant container.

After attaching the generated information to the information/data related to the tenant container, the first tenant container performs steps 906, 907, and 908.

At step 906, the first tenant container logs the generated information. At step 907, the first tenant container encrypts the information related to the first tenant container attached with the information indicating that the probe is enabled in the secure environment/TEE. The first tenant container transmits the encrypted information to the second tenant container.

At step 908, the first tenant container identifies that more encrypted information has to be transmitted and starts performing from steps 903.

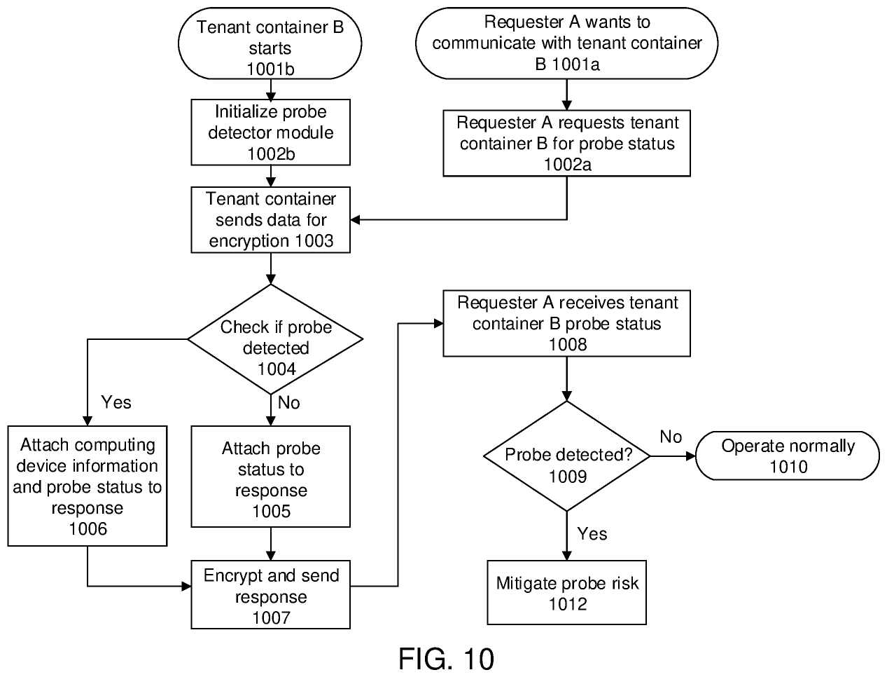

FIG. 10 is another flowchart illustrating example method steps performed by the second tenant container to secure the first tenant container being executed on the first computing device. In some examples, the second tenant container being executed on the same first computing device on which the first tenant container is being executed. In some examples, the second tenant container being executed on the second computing device different from the first computing device on which the first tenant container is being executed. The second tenant container being executing on the same computing device or the different computing device may be referred to as a “requester A”, and the first tenant container which is to be secured is referred to as “tenant container B”, as depicted in FIG. 10. In some examples, the “requester A” may be a computing device, for example, a second computing device.

At step 1001a, the requester A wants to communicate with the tenant container B. At step 1002a, the requester A transmits a request to the tenant container B for a probe status. The probe status indicates whether the information related to the tenant container B is probed or not (that is the information of the tenant container is being collected by the probe enabled on the tenant container).

Meanwhile, at step 1001b, the tenant container B is being executed on the first computing device. At step 1002b, the tenant container B initializes configurations of the probe detector module.

At step 1003, the tenant container B transmits the produced information/data for encryption and receives the request from the requester A for the probe status.

Upon receiving the request for the probe status, at step 1004, the tenant container B checks whether the probe is detected/enabled on the tenant container B to collect the information from the tenant container B.

Upon checking that the probe has not been detected, at step 1005, the tenant container B attaches the probe status indicating that no probe has been detected to a response. At step 1007, the tenant container B encrypts the response attached with the probe status and transmits the response to the requester A.

Upon checking that the probe has been detected, at step 1006, the tenant container B generates the information indicating that the probe is detected/enabled and attaches the generated information to the response. The generated information includes information related to the first computing device on which the tenant container B is being executed and the probe status indicating that the probe has been detected/enabled. After attaching the generated information to the response, at step 1007, the tenant container B encrypts the response attached with the generated information and transmits the encrypted information to the requester A.

At step 1008, the requester A receives the response including the probe status from the tenant container B.

Upon reception, at step 1009, the requester A verifies whether the probe has been detected collecting the information related to the tenant container B, based on the received response including the information related to the first computing device and the probe status.

When it has been verified that the probe has not been detected, at step 1010, the requester A operates normally, for example, the requester A may start transmitting its information to the tenant container B.

When it has been verified that the probe has been detected, at step 1012, the requester A mitigates effects of existence of the probe (i.e., probe risk). The requester A mitigates the probe risk by controlling transmission of its information to the tenant container B. In some examples, controlling the transmission comprises one or more of: terminating transmission of the information from the requester A to the tenant container B, rejecting the tenant container B as a receiver, and delivering the information related to the tenant container B only in a secure environment of the tenant container B. In some examples, the requester A may reject the tenant container B as the receiver by evaluating one or more factors along with the probe status. Examples of the one or more factors may include, but are not limited to, an identity and a geographical location of the computing device on which the tenant container B is executing, an expected information from the requester A in the response, a result of detecting whether collection of the information is a respectful collection/execution (i.e., identifying whether the process external to the tenant container is accessing the at least one file, for example, a filtering rule set, from the tenant container), and so on.

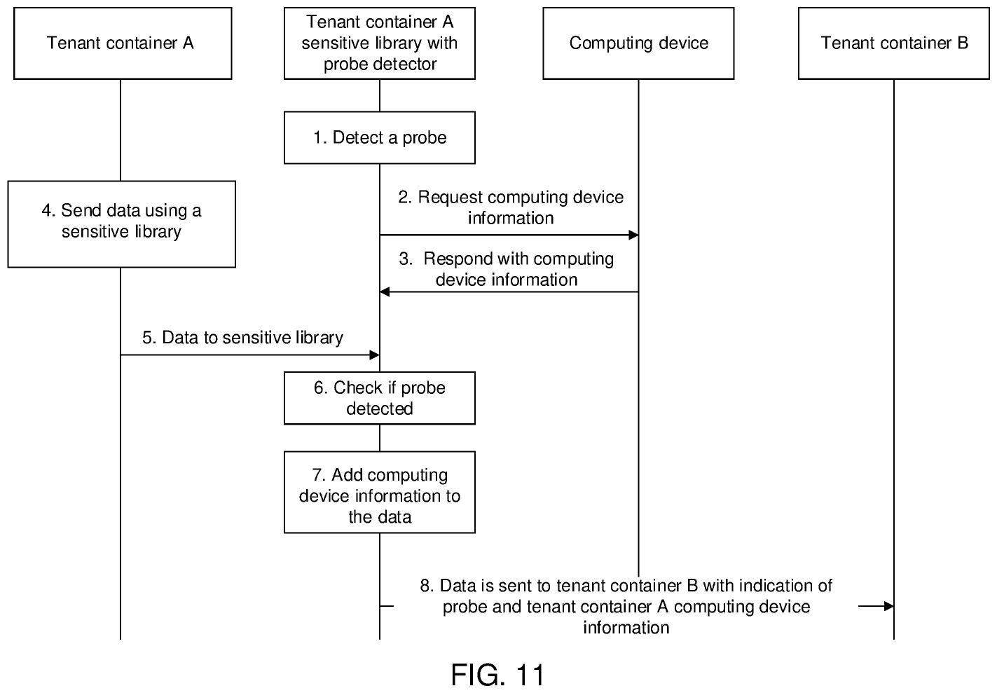

FIG. 11 is a signaling diagram illustrating example signaling for securing the tenant container. The signaling diagram depicted in FIG. 11 illustrates how the tenant container, for example, a tenant container A (i.e., a first tenant container), may inform another tenant container, for example, a tenant container B (i.e., a second tenant container), when the probe is detected locally. In some examples, the tenant container B may reside in the same first computing device on which the tenant container A is being executed. In some examples, the tenant container B may reside in the second computing device different from the computing device on which the tenant container A is being executed.

The probe detector module attached to the sensitive library of the tenant container A detects (1) that the probe is enabled and the probe starts monitoring the sensitive library of the tenant container A to collect the information.

Upon detection of the probe, the probe detector module requests (2) the first computing device for providing information related to the first computing device.

In response to the received request, the first computing device provides (3) the information about itself to the probe detector module.

The tenant container A decides (4) and transmits (5) the produced information/data to the sensitive library for encryption and transmission.

When the tenant container A transmits the information to the sensitive library, the probe detector module attached to the sensitive library detects/checks (6) whether the probe is enabled to collect the information related to the tenant container A.

Upon detection that the probe is enabled to collect the information related to the tenant container A, the tenant container A generates (7) information indicating that the probe is enabled and attaches the generated information to the produced information. In some examples, the generated information may include, but is not limited to, the information related to the computing device, and an indication/probe indication representing that the probe is enabled/detected. Further, the tenant container A encrypts its information along with the generated information using the sensitive library.

The tenant container A transmits (8) the encrypted information to the tenant container B. As a result, the tenant container B successfully identifies the detection of probe on the tenant container A from the information related to the first computing device, and the indication bundled with the original information of the tenant container A.

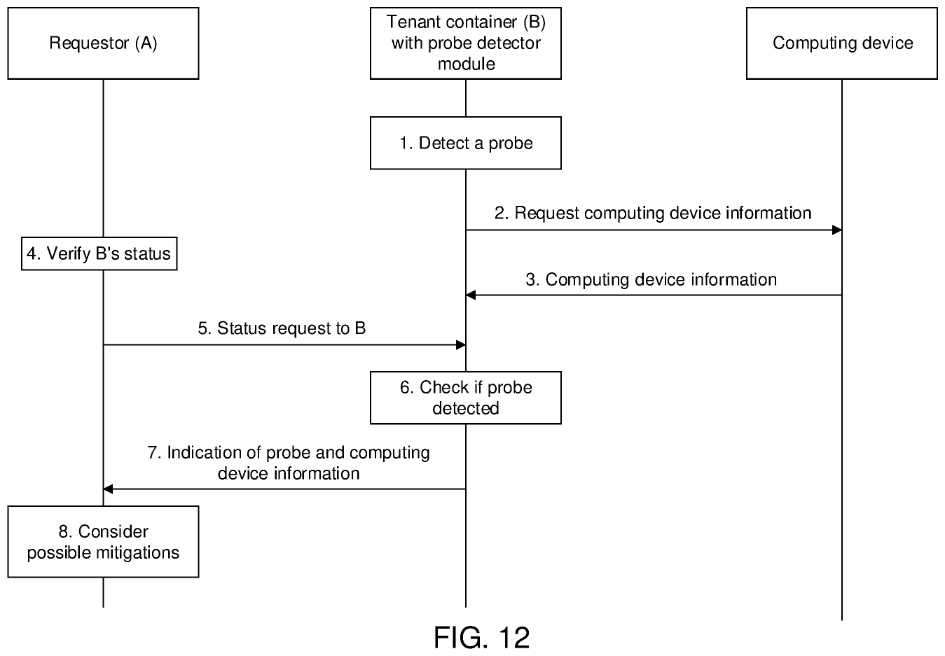

FIG. 12 is another signaling diagram illustrating example signaling for securing the tenant container.

The signaling diagram depicted in FIG. 12 illustrates how a requester, for example, a requester A, may communicate with the tenant container, for example, a tenant container B, based on a probe status. In some examples, the requester A may be a computing device with or without comprising any tenant container. In some examples, the requester A may be a tenant container, for example, a tenant container A. In some examples, the tenant container A may reside in the same first computing device on which the tenant container B is being executed.

In some examples, the tenant container A may reside in the second computing device different from the computing device on which the tenant container B is being executed.

As depicted in FIG. 12, the probe detector module attached to a sensitive library of the tenant container B identifies (1) that the probe is enabled on the tenant container B and the probe started monitoring to the sensitive library.

The probe detector module requests (2) the first computing device on which the tenant container B is being executed to provide information related to the first computing device. The first computing device provides (3) the information about itself to the probe detector module.

Meanwhile, the requester A wants (4) to know the current probe status/state of the tenant container B in order to communicate with the tenant container B. Therefore, the requester A transmits a request/status request to the tenant container B.

Upon receiving the request for the probe status, the probe detector module in the tenant container B checks/detects whether the probe is enabled on the tenant container B to collect the information related to the tenant container B.

When it has been detected that the probe is enabled, the tenant container B generates and attaches (7) information indicating that the probe is enabled to a response/probe status response. The generated information includes information related to the computing device and an indication/probe indication representing that the probe is enabled. The tenant container B transmits the response to the requester A.

Upon receiving the response, the requester A verifies if the probe has been detected on the tenant container B using the received response. When it has been verified successfully that the probe has been detected on the tenant container B, the requester A decides (8) to mitigate risk of the probe by controlling transmission of its information to the tenant container B.

In some examples, controlling the transmission comprises one or more of: terminating transmission of the information from the requester A to the tenant container B, rejecting the tenant container B as a receiver, and delivering the information related to the tenant container B only in a secure environment on the tenant container B. In some examples, the requester A may reject the tenant container B as the receiver by evaluating one or more factors along with the probe status.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

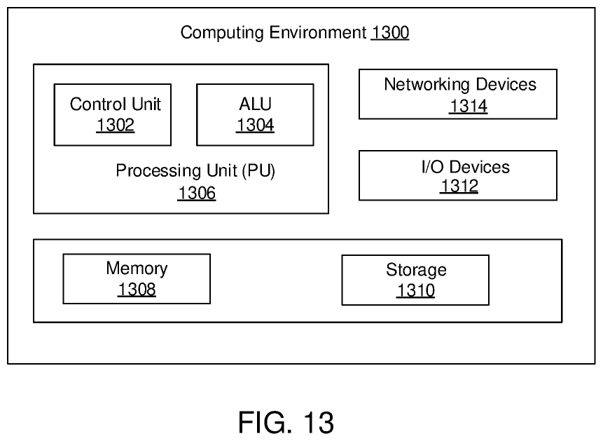

FIG. 13 illustrates an example computing environment 1300 implementing a method and the computing device, as described in FIGS. 3 and 4. As depicted in FIG. 13, the computing environment 1300 comprises at least one data processing module 1306 that is equipped with a control module 1302 and an Arithmetic Logic Unit (ALU) 1304, a plurality of networking devices 1308 and a plurality Input output, I/O devices 1310, a memory 1312, a storage 1314. The data processing module 1306 may be responsible for implementing the method described in FIGS. 3 and 4. For example, the data processing module 1306 may in some embodiments be equivalent to the CPU/processor of the computing device described above in conjunction with the FIGS. 2A and 2B. The data processing module 1306 is capable of executing software instructions stored in memory 1312. The data processing module 1306 receives commands from the control module 1302 in order to perform its processing. Further, any logical and arithmetic operations involved in the execution of the instructions are computed with the help of the ALU 1304.

The computer program is loadable into the data processing module 1306, which may, for example, be comprised in an electronic apparatus (such as a computing device). When loaded into the data processing module 1306, the computer program may be stored in the memory 1312 associated with or comprised in the data processing module 1306. According to some embodiments, the computer program may, when loaded into and run by the data processing module 1306, cause execution of method steps according to, for example, any of the method illustrated in FIGS. 3 and 4 or otherwise described herein.

The overall computing environment 1300 may be composed of multiple homogeneous and/or heterogeneous cores, multiple CPUs of different kinds, special media and other accelerators. Further, the plurality of data processing modules 1306 may be located on a single chip or over multiple chips.

The algorithm comprising of instructions and codes required for the implementation are stored in either the memory 1312 or the storage 1314 or both. At the time of execution, the instructions may be fetched from the corresponding memory 1312 and/or storage 1314, and executed by the data processing module 1306.

In case of any hardware implementations various networking devices 1308 or external I/O devices 1310 may be connected to the computing environment to support the implementation through the networking devices 1308 and the I/O devices 1210.

The embodiments disclosed herein can be implemented through at least one software program running on at least one hardware device and performing network management functions to control the elements. The elements shown in FIG. 13 include blocks which can be at least one of a hardware device, or a combination of hardware device and software module.

1-29. (canceled)

30. A method for securing a first tenant container executed by a first computing device, the method being performed within the first tenant container by the first computing device, the method comprising:
detecting whether a probe for collecting information related to the first tenant container is enabled within one or more processes being executed on the first computing device;
upon detection that the probe for collecting the information related to the first tenant container is enabled, generating information indicating that the probe is enabled on the first tenant container; and
in response to the detection, performing one or more of: transmitting the generated information indicating that the probe is enabled along with the information related to the first tenant container to a second tenant container or a second computing device, logging the detection of the probe, and modifying at least one functionality within the first tenant container.

31. The method of claim 30, further comprising:
encrypting the generated information indicating that the probe is enabled along with the information related to the first tenant container.

32. The method of claim 31, further comprising:
transmitting the information for execution of the encryption in a secure environment before transmission.

33. The method of claim 30, wherein the step of detecting whether the probe is enabled within the one or more processes being executed on the first computing device for collecting the information related to the first tenant container comprises:
receiving a request for a probe status indicating whether the first tenant container is probed for collecting the information related to the first tenant container; and
upon receiving the request, verifying whether the probe is detected as enabled within the one or more processes being executed on the first computing device.

34. The method of claim 33, wherein the request for the probe status is received from one or more of:
the second tenant container residing in the first computing device;
a tenant container external to the first computing device; and
the second computing device.

35. The method of claim 31, wherein the step of detecting whether the probe is enabled within the one or more processes being executed on the first computing device comprises:
monitoring one or more libraries of the first tenant container; and
identifying whether one or more libraries of the first tenant container are being accessed from outside of the first tenant container.

36. The method of claim 31, wherein the step of detecting whether the probe is enabled within the one or more processes being executed on the first computing device comprises:
identifying whether at least one file belonging to the first tenant container is being accessed by a process external to the first tenant container.

37. The method of claim 36, wherein the at least one file comprises one or more of: a cryptographic key, and a filtering rule set.

38. The method of claim 31, wherein the generated information comprises one or more of:
an identity of the first computing device;
a geographical location of the first computing device;
a provider identity of the first computing device;
information about a central processing unit, CPU of the first computing device;
information about a kernel of the first computing device;
information about available drives of the first computing device; and
information about a result of identifying whether the at least one file belonging to the first tenant container is being accessed by the process external to the first tenant container.

39. The method of claim 31, further comprising:
performing one or more of:
aborting transmission of the information from the first tenant container;
transmitting only specific or at least some of the information related to the first tenant container;
transmitting an indication that the first tenant container is probed for collection of the information by the one or more processes executed by the first computing device;
aborting execution of one or more functions and/or libraries of the first tenant container when the probe is enabled; and
transmitting an indication to indicate that the one or more functions of the first tenant container to be moved to second computing device.

40. A method for securing a first tenant container, the method being performed within a second tenant container executed by a second computing device, the method comprising:
transmitting a request to the first tenant container being executed on a first computing device for a probe status indicating whether the first tenant container is probed for collecting the information related to the first tenant container;
receiving, from the first tenant container, information indicating whether the probe is enabled on the first tenant container along with the information related to the first tenant container; and
upon reception of the information indicating that the probe is enabled, controlling transmission of information related to the second tenant container to the first tenant container.

41. The method of claim 40, wherein the step of receiving the information indicating whether the probe is enabled on the first tenant container along with the information related to the first tenant container comprises:
receiving, from the first tenant container, an indication that one or more processes being executed on the first computing device are collecting the information related to the first tenant container in accordance with a filtering rule set.

42. The method of claim 40, wherein the step of controlling transmission of the information related to the second tenant container comprises performing one or more of:
terminating transmission of the information related to the second tenant container to the first tenant container;
rejecting the first tenant container as a receiver; and
delivering the information related to the first tenant container only to a secure environment within the first tenant container.

43. The method of claim 40, wherein the received information comprises one or more of:
an identity of the first computing device;
a geographical location of the first computing device;
a provider identity of the first computing device;
information about a central processing unit, CPU of the first computing device;
information about a kernel of the first computing device; and
information about available drives of the first computing device.

44. A first computing device for securing a first tenant container from within the first tenant container, the first computing device comprising processing circuitry configured to:
detect whether a probe for collecting information related to the first tenant container is enabled within one or more processes being executed on the first computing device;
upon detection that the probe for collecting the information related to the first tenant container is enabled, generate information indicating that the probe is enabled on the first tenant container; and
in response to detection, perform one or more of: transmitting the generated information indicating that the probe is enabled along with the information related to the first tenant container to a second tenant container or a second computing device, logging the detection of the probe, and modifying at least one functionality within the first tenant container.

45. The first computing device of claim 44, wherein the processing circuitry is further configured to:
encrypt the generated information indicating that the probe is enabled along with the information related to the first tenant container.

46. The first computing device of claim 45, wherein the processing circuitry is further configured to:
transmit the information for execution of the encryption in a secure environment before transmission.

47. The first computing device of claim 44, wherein the processing circuitry is configured to detect whether the probe is enabled within the one or more processes being executed on the first computing device for collecting the information related to the first tenant container by:
receiving a request for a probe status indicating whether the first tenant container is probed for collecting the information related to the first tenant container; and
upon receiving the request, verifying whether the probe is detected as enabled within the one or more processes being executed on the first computing device.

48. A second computing device for securing a first tenant container from within a second tenant container, the second computing device comprising processing circuitry configured to:
transmit a request to the first tenant container being executed on a first computing device for a probe status indicating whether the first tenant container is probed for collecting the information related to the first tenant container;
receive, from the first tenant container, information indicating whether the probe is enabled on the first tenant container along with the information related to the first tenant container; and
upon reception of the information indicating that the probe is enabled, control transmission of information related to the second tenant container to the first tenant container.

49. A computer program product comprising a non-transitory computer readable medium, having thereon a computer program comprising program instructions, the computer program is loadable into a data processing unit and configured to cause execution of the method of claim 30 when the computer program is run by the data processing unit.
